(19) United States
(12) Patent Application Publication
(10) Pub. No.: US 2022/0395888 A1
(43) Pub. Date: Dec. 15, 2022

(54) A BI-DIRECTIONAL AND DOUBLE-PUNCH BALANCED HIGH-SPEED BODYMAKER

(71) Applicant: SUZHOU SLAC PRECISION EQUIPMENT CO., LTD, Suzhou, Jiangsu Province (CN)

(72) Inventors: Shu AN, Suzhou (CN); Lingguang KONG, Suzhou (CN); Yang WANG, Suzhou (CN)

(73) Assignee: SUZHOU SLAC PRECISION EQUIPMENT CO., LTD, Suzhou, Jiangsu Province (CN)

(21) Appl. No.: 17/775,634

(22) PCT Filed: Mar. 31, 2020
(86) PCT No.: PCT/CN2020/082559

§ 371 Date: May 10, 2022

(30) Foreign Application Priority Data
Nov. 11, 2019 (CN) 201911092484.6

(51) Int. Cl. B21D 51/26

(52) U.S. Cl. CPC B21D 51/2669

(57) ABSTRACT

A bi-directional and double-punch balanced high-speed bodymaker includes a punch driving mechanism and blank pressing mechanism, wherein: the punch driving mechanism includes a crankshaft, two identical connecting rods, slide rails, sliders and punches. The crankshaft is rotationally supported by a bearing, and the crankshaft has a first crank, second crank and first and second blank pressing cams. Compared with the prior art, the swing lever and secondary connection are removed from each set of punch driving mechanism, simplifying the structure while maintaining all original functions, constituting omitting elements. It adopts two blank pressing cams and arranges the first blank pressing cam driving point of the opposite the second blank pressing cam driving point, and finally, the directions of the first and second torque are opposite and counteract each other, to maintain balance of overall torque on the plane passing the crankshaft axis during the operation of the bodymaker.

### TECHNICAL FIELD

The present invention relates to a can body making machine, in particular to a bi-directional and double-punch bodymaker with better balance of process force and torque under high-speed working conditions (drawing speed of 400 times/min). The so-called can body refers to the metal components with the shape of a can body, such as the can body of a ring-pull can, the can body of a battery case and other metal objects with the shape of a can body.

### BACKGROUND OF INVENTION

Metal can bodies are widely used in people's daily lives and industries. The typical can bodies are the can bodies of ring-pull cans and cases of the lithium battery in the power battery. The annual use of these can bodies is very huge, especially the can bodies of ring-pull cans. With the continuous improvement of people's living standards, the demand for ring-pull cans is also increasing.

Ring-pull cans are usually made of aluminum and iron. Its structure is composed of a can body and easy open end. And the can body is formed by drawing metal sheets through a bodymaker. The existing bodymaker is usually composed of a cup feeding mechanism, a blank pressing mechanism, a punch driving mechanism, a drawing die and a can discharging mechanism. Among them, the cup feeding mechanism is used to transport the can blank before drawing (cup-shaped member to be drawn), the blank pressing mechanism is used to compress the can blank during drawing, the punch driving mechanism is used to provide the punching stroke during can drawing, the drawing die is used to draw the can body, and the can discharging mechanism is used to discharge and output the can body after drawing. For the bodymaker, its technical core lies in the design and layout of punch driving mechanism and blank pressing mechanism. With the technology improvement and market demand, the bodymaker is developing in the direction of high speed and high quality. It is required to continuously improve the drawing speed (drawing speed of 400 times/min), while it is also required to complete the drawing forming of the can body with high quality. This puts forward very high requirements for the balance of process force and torque of bodymaker in its own idle stroke. Therefore, how to maintain the balance of process force and torque of the bodymaker under the condition of high-speed operation is a technical problem in the art.

Chinese patent CN102581107A discloses a utility patent with the title of a bi-directional and double-punch bodymaker and with application No. 201210040629. The patent designs two sets of punch driving mechanisms which are arranged in a symmetrical layout to share a crankshaft to balance the process force and torque of swing lever, slider, punch and other components in motion and the reacting force generated in the process of can body forming, which significantly reduces the load of crankshaft support bearing, reduces the requirements for bearing design and processing and prolongs the service life. Although the patent has achieved obvious results in reducing process force and torque through the symmetrical layout of two sets of punch mechanisms, it still has the following problems: first, the structure is complicated and there are many moving parts. The patent scheme has two sets of punch driving mechanisms and each set of punch driving mechanism is composed of crankshaft, main connecting rod, swing lever, secondary connecting rod, guide rail, slider and punch, and the swing lever can enlarge the punching stroke and reduce the radius of crank at the same time; and the secondary connecting rod can reduce the pressure angle between the slider and the guide rail, which is conducive to the accuracy and stability of the sliding mechanism. However, the existence of the swing lever and the secondary connecting rod also makes the overall size of the equipment larger, makes the mechanism more complicated, and increases the number of moving parts. Second, there are still deficiencies in the overall layout and stress of the machine. For example, when the first layout design shown in FIG. 5 of the patent is applied, since the two swing levers maintain symmetrical during movement, the process force and torque of the machine in the horizontal direction can be balanced, but they are not only unbalanced in the vertical direction, but also superimposed on each other. If the second layout design shown in FIG. 9 of the patent is applied, although they can be basically balanced from the perspective of process force and torque in the horizontal and vertical directions, the structure becomes very complicated and there is a large drop between the left and right drawing stations in the vertical direction.

In view of this, how to design a bi-directional and double-punch bodymaker with simpler structure and more conducive to the balance of process force and torque is the research subject of the present invention.

### DISCLOSURE OF THE INVENTION

The invention provides a bi-directional and double-punch balanced high-speed bodymaker, which aims to solve the problems of complicated structure and poor balance of process force and torque of the existing bi-directional and double-punch bodymaker.

In order to achieve the above purpose, the technical scheme adopted by the invention is: a bi-directional and double-punch balanced high-speed bodymaker, which comprises a punch driving mechanism and a blank pressing mechanism, wherein: the punch driving mechanism is composed of the following components:

A crankshaft, said crankshaft is rotationally supported by a bearing, and the crankshaft is provided with a first crank, a second crank, a first blank pressing cam and a second blank pressing cam.

Two connecting rods, i.e. the first connecting rod and the second connecting rod.

Two slide rails, i.e. the first slide rail and the second slide rail.

Two sliders, i.e. the first slider and the second slider.

Two punches, i.e. the first punch and the second punch.

Wherein:

The first crank is rotationally connected with the one end of the first connecting rod, and the other end of the first connecting rod is rotationally connected with the first slider, and the first slider is mounted on the first slide rail and slidably connected with the first slide rail, and the first slide rail is fixed relative to the base of the bodymaker, and the first slider is fixedly connected with the first punch.

The second crank is rotationally connected with one end of the second connecting rod, and the other end of the second connecting rod is rotationally connected with the second slider, and the second slider is mounted on the second slide rail and slidably connected with the second slide rail, and the second slide rail is fixed relative to the base of the bodymaker, and the second slider is fixedly connected with the second punch.

The first crank, the first connecting rod, the first slider, the first slide rail, the first punch and the first blank pressing cam are located at one end of the crankshaft and form a first punch driving mechanism; the second crank, the second connecting rod, the second slider, the second slide rail, the second punch and the second blank pressing cam are located at the other end of the crankshaft and form a second punch driving mechanism.

The blank pressing mechanism is composed of a first blank pressing mechanism and a second blank pressing mechanism, wherein the first blank pressing mechanism is arranged corresponding to the first punch driving mechanism, the first blank pressing cam is drivingly connected with the first blank pressing mechanism and has a first driving point, the second blank pressing mechanism is arranged corresponding to the second punch driving mechanism, and the second blank pressing cam is drivingly connected with the second blank pressing mechanism and has a second driving point.

On the plane transverse to the crankshaft axis, the first punch driving mechanism and the second punch driving mechanism are symmetrically arranged with the rotation center point of the crankshaft as the reference, so as to maintain the balance of overall stress on the plane transverse to the crankshaft axis during the operation of the bodymaker.

On the plane passing the crankshaft axis, the turning direction of the first crank is opposite to that of the second crank, and the first blank pressing cam and the second blank pressing cam are fixedly connected relative to the crankshaft, and at the same time, on the plane passing the crankshaft axis, the first driving point of the first blank pressing cam is opposite to the second driving point of the second blank pressing cam; under the working state, the drawing force applied by the first connecting rod to the first crank is defined as the first drawing force, and the drawing force applied by the second connecting rod to the second crank is defined as the second drawing force, the blank pressing force applied by the first blank pressing mechanism to the first blank pressing cam is defined as the first blank pressing force, and the blank pressing force applied by the second blank pressing mechanism to the second blank pressing cam is defined as the second blank pressing force; on the plane passing the crankshaft axis, the first drawing force and the second drawing force are parallel and opposite to each other and form a first torque, the first blank pressing force and the second blank pressing force are parallel and opposite to each other and form a second torque, and the first torque is opposite to the direction of the second torque, so as to maintain the balance of overall torque on the plane passing the crankshaft axis during the operation of the bodymaker.

The above described technical solution is explained as follows:

1. In above described technical solution, as a complete machine, the bodymaker also includes a box body, two sets of dies, two sets of cup feeding mechanisms and two sets of can discharging mechanisms. Since the innovation of the present invention is embodied in the punch driving mechanism and blank pressing mechanism, and the existing technology can be adopted for the above mechanisms, so there is no detailed description and introduction of them in the above solution, which can be understood and accepted by those skilled in the art.
2. In above described technical solution, the “blank pressing mechanism” refers to the mechanism that compresses the can blank when the can body is drawn (pressed at the bottom edge of the can blank). It is an indispensable part of the bodymaker, but the specific structure and form of the blank pressing mechanism in the present invention do not affect the expression and embodiment of the innovative content of the invention. Therefore, in above described technical solution, only the term of blank pressing mechanism is defined, and its specific structure and form are not defined.
3. In above described technical solution, “on the plane transverse to the axis of crankshaft 1” is equivalent to the plane shown in FIG. 1. And “on the plane passing the axis of crankshaft 1” is equivalent to the plane shown in FIG. 2.
4. In above described technical solution, the “blank pressing force” refers to the process force used to compress the can blank during the drawing process of the can body, excluding the inertial force during the movement of the mechanism. The “drawing force” refers to the process force used to draw the can blank during the drawing process of the can body, excluding the inertial force during the movement of the mechanism.
5. In above described technical solution, the first crank and the second crank are arranged adjacently in the axial direction of the crankshaft, the first blank pressing cam is arranged outside the axial direction of the first crank, and the second blank pressing cam is arranged outside the axial direction of the second crank.
6. In above described technical solution, the first blank pressing cam and the second blank pressing cam are arranged adjacently in the axial direction of the crankshaft, the first crank is arranged outside the axial direction of the first blank pressing cam, and the second crank is arranged outside the axial direction of the second blank pressing cam.

The design principle and conception of the invention are: in order to solve the problems of complicated structure and poor balance of process force and torque of the existing bi-directional and double-punch bodymaker, the invention has made the following two improvements and breakthroughs in the structural design of the bodymaker.

First, for the existing bi-directional and double-punch bodymaker (CN102581107A, scheme in FIG. 5), the swing lever and secondary connection are removed in each set of punch driving mechanism, and the other end of the main connecting rod is directly and rotationally connected to the slider. Thus, the most important punch driving mechanism in the structure of bodymaker is simplified.

Second, in the structural design of crankshaft, the first blank pressing cam is designed for the first crank and the second blank pressing cam is designed for the second crank. At the same time, the blank pressing force of the first blank pressing mechanism acting on the first blank pressing cam and the blank pressing force of the second blank pressing mechanism acting on the second blank pressing cam are designed to be parallel to each other and in opposite directions. Finally, the technical measure of the opposite direction of the first torque and the second torque can be used to achieve the purpose of torque balance.

Due to the application of the above described technical solution, the present invention has the following advantages and effect in comparison with the existing bi-directional and double-punch bodymaker:

1. The invention removes the swing lever and secondary connection in each set of punch driving mechanism. From the perspective of actual effect, it not only greatly simplifies the structure, but also maintains all the original functions. From the perspective of invention and innovation, it constitutes the omission of elements, so it has prominent substantive features. For the existing bi-directional and double-punch bodymaker (CN102581107A, scheme in FIG. 5), the swing lever can enlarge the punching stroke and reduce the radius of crank at the same time; and the secondary connecting rod can reduce the pressure angle between the slider and the guide rail, which is conducive to the accuracy and stability of the sliding mechanism. However, the existence of the swing lever and the secondary connecting rod also makes the overall size of the equipment larger, makes the mechanism more complicated, and increases the number of moving parts. From the design of the existing bi-directional and double-punch bodymaker, it seems that the swing lever and secondary connection cannot be removed in the punch driving mechanism, but the invention has made a bold breakthrough in structural design, which is obviously non-obvious to those skilled in the art. As for some stress and balance problems that may be caused by removal of the swing lever and secondary connecting rod, they can be solved by the arrangement of blank pressing cam.
2. The first blank pressing cam and the second blank pressing cam are specially arranged in the structural design of the crankshaft in the invention. This design plays a very important role in the stress and balance of the punch driving mechanism. It's known to those skilled in the art that the punch driving mechanism is the core of the bodymaker and a moving mechanism with big stress and inertia. Especially in the high-speed working state (drawing speed of 400 times/min), the balance of process force and torque is particularly prominent from the perspective of the whole machine, which not only affects the service life of the machine, but also directly affects the drawing quality and effect. For the existing bi-directional and double-punch bodymaker (CN102581107A), FIG. 5 shows the design of first layout, and since the two swing levers maintain symmetrical during movement, the process force and torque of the machine in the horizontal direction (the transverse direction shown in FIG. 5, relative to the left-right direction of “on the plane transverse to the crankshaft axis” described in the present invention) can be balanced, but in the horizontal plane (relative to the left-right direction of “on the plane passing the crankshaft axis” described in the present invention), since the drawing force of the first connecting rod to the first crank and the drawing force of the second connecting rod to the second crank are parallel and opposite to each other, a first torque is formed, resulting in the unbalanced bearing force of the crankshaft and the supporting shaft. Particularly, after the removal of the swing lever, the present invention increases the radius of the crank in order to achieve the punching stroke, which makes the problem of torque balance particularly prominent and increases the impact and load on the crankshaft support bearing. In order to solve this problem, the present invention adopts two blank pressing cams and arranges the first driving point of the first blank pressing cam opposite to the second driving point of the second blank pressing cam, and finally, on the plane passing the crankshaft axis, the directions of the first torque and the second torque are opposite and they counteract each other, so as to maintain the balance of overall torque on the plane passing the crankshaft axis during the operation of the bodymaker. It can be seen that the present invention not only absorbs the advantages of the existing bi-directional and double-punch bodymaker (CN102581107A) in maintaining the balance of overall stress on the plane transverse to the crankshaft axis, but also overcomes the deficiency of the existing bi-directional and double-punch bodymaker (CN102581107A) in the torque imbalance on the plane passing the crankshaft axis, and achieves remarkable effect, so as to maintain the balance of overall torque on the plane passing the crankshaft axis during the operation of the bodymaker.
3. The present invention can realize installation without foundation. Bodymaker is a large-scale drawing machine, and the foundation is usually required due to large process force, torque and vibration of the machine, especially in the high-speed working state (drawing speed of 400 times/min). At this time, a one meter deep pit needs to be excavated, and then a large concrete foundation needs to be poured. Finally, the bodymaker is fixed on the concrete foundation. Since the balance factor of force and torque is fully considered in the design of the whole machine, the foundation is not required for the installation of the manufactured machine, which brings great convenience to the installation and construction and saves the installation cost.

### BRIEF DESCRIPTION OF THE DRAWINGS

FIG. 1 is the schematic diagram of the punch driving mechanism of the present invention;

FIG. 2 is a schematic diagram of the crankshaft of the present invention;

FIG. 3 is a perspective view of the punch driving mechanism of present invention;

FIG. 4 is a perspective view of the crankshaft of present invention.

In the above figures: 1. Crankshaft; 11. First crank; 12. Second crank; 13. First blank pressing cam; 14. Second blank pressing cam; 2. Connecting rod; 21. First connecting rod; 22. Second connecting rod; 3. Slide rail; 31. First slide rail; 32. Second slide rail; 4. Slider; 41. First slider; 42. Second slider; 5. Punch; 51. First punch; 52. Second punch; F1. First drawing force; F2. Second drawing force; F3. First blank pressing force; F4. Second bland pressing force; N1. First torque; N2. Second torque.

### SPECIFIC EMBODIMENT

With reference to the accompanying drawings and embodiment, the present invention will be described in detail.

### Embodiment: A Bi-Directional and Double-Punch Balanced High-Speed Bodymaker

The bodymaker is composed of a box body, two sets of dies, two sets of blank pressing mechanisms, two sets of cup feeding mechanisms, two sets of punch driving mechanisms and two sets of can discharging mechanisms, and since the innovation of the present invention is embodied in the punch driving mechanisms and blank pressing mechanisms, and the existing technology can be adopted for the other mechanisms, so there is no detailed description and introduction of them in the embodiment, which can be understood and accepted by those skilled in the art.

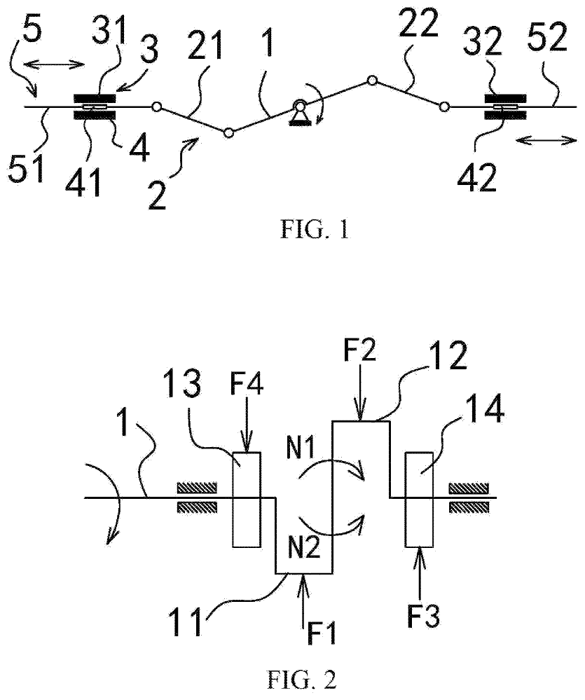

Refer to FIGS. 1-4, the punch driving mechanism is composed of the following components:

A crankshaft 1 (see FIGS. 2 and 4), and the crankshaft 1 is rotationally supported by a bearing, and the crankshaft 1 is provided with a first crank 11, a second crank 12, a first blank pressing cam 13 and a second blank pressing cam 14. The first crank 11 and the second crank 12 are arranged adjacently in the axial direction of the crankshaft 1, the first blank pressing cam 13 is arranged outside the axial direction of the first crank 11, and the second blank pressing cam 14 is arranged outside the axial direction of the second crank 12 (see FIG. 2).

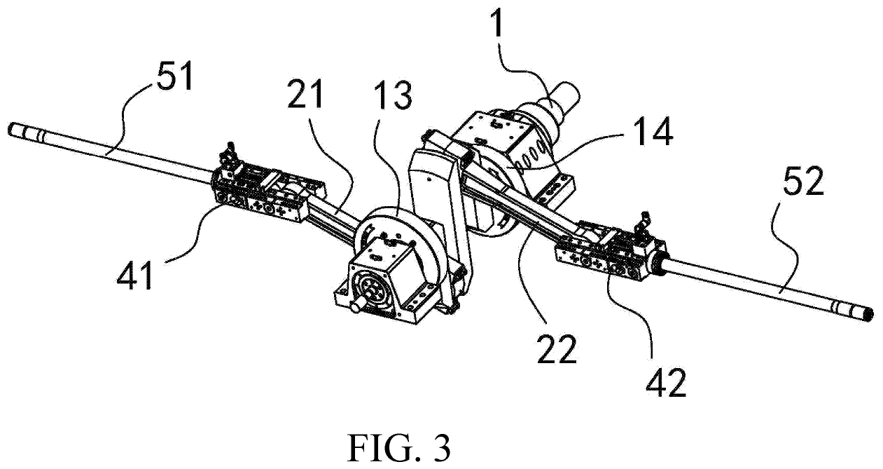

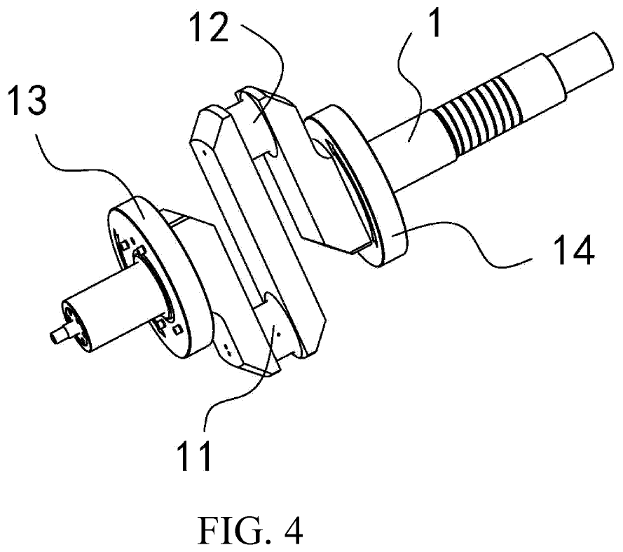

Two identical connecting rods 2, i.e. the first connecting rod 21 and the second connecting rod 22 (see FIGS. 1 and 3).

Two identical slide rails 3, i.e. the first slide rail 31 and the second slide rail 32 (see FIG. 1).

Two identical sliders 4, i.e. the first slider 41 and the second slider 42 (see FIGS. 1 and 3).

Two identical punches 5, i.e. the first punch 51 and the second punch 52 (see FIGS. 1 and 3).

Wherein:

The first crank 11 is rotationally connected with the one end of the first connecting rod 21, and the other end of the first connecting rod 21 is rotationally connected with the first slider 41, and the first slider 41 is mounted on the first slide rail 31 and slidably connected relative to the first slide rail 31, and the first slide rail 31 is fixed relative to the base of the bodymaker, and the first slider 41 is fixedly connected with the first punch 51 (see FIGS. 1 and 3).

The second crank 12 is rotationally connected with one end of the second connecting rod 22, and the other end of the second connecting rod 22 is rotationally connected with the second slider 42, and the second slider 42 is mounted on the second slide rail 32 and slidably connected relative to the second slide rail 32, and the second slide rail 32 is fixed relative to the base of the bodymaker, and the second slider 42 is fixedly connected with the second punch 52 (see FIGS. 1 and 3).

The first crank 11, the first connecting rod 21, the first slider 41, the first slide rail 31, the first punch 51 and the first blank pressing cam 13 are located at one end of the crankshaft 1 and form a first punch driving mechanism (see FIGS. 1 and 3). The second crank 12, the second connecting rod 22, the second slider 42, the second slide rail 32, the second punch 52 and the second blank pressing cam 14 are located at the other end of the crankshaft 1 and form a second punch driving mechanism (see FIGS. 1 and 3).

The blank pressing mechanism is composed of a first blank pressing mechanism and a second blank pressing mechanism, wherein the first blank pressing mechanism is arranged corresponding to the first punch driving mechanism, the first blank pressing cam 13 is drivingly connected with the first blank pressing mechanism and has a first driving point, the second blank pressing mechanism is arranged corresponding to the second punch driving mechanism, and the second blank pressing cam 14 is drivingly connected with the second blank pressing mechanism and has a second driving point. In this embodiment, the specific structures of the first blank pressing mechanism and the second blank pressing mechanism are not important, the prior art can be adopted without affecting the implementation and effect of the present invention, as long as the first blank pressing cam 13 can drive the first blank pressing mechanism to compress the edge of the can blank before the can body is drawn.

On the plane transverse to the axis of crankshaft 1 (the plane shown in FIG. 1), the first punch driving mechanism and the second punch driving mechanism are symmetrically arranged with the rotation center point of the crankshaft as the reference, so as to maintain the balance of overall stress on the plane transverse to the axis of crankshaft 1 during the operation of the bodymaker (see FIG. 1).

On the plane passing the axis of crankshaft 1 (the plane shown in FIG. 2), the turning direction of the first crank 11 is opposite to that of the second crank 12, and the first blank pressing cam 13 and the second blank pressing cam 14 are fixedly connected relative to the crankshaft 1, and at the same time, on the plane passing the crankshaft 1 axis, the first driving point of the first blank pressing cam 13 is opposite to the second driving point of the second blank pressing cam 14; in the working state, the drawing force applied by the first connecting rod 21 to the first crank 11 is defined as the first drawing force F1, and the drawing force applied by the second connecting rod 22 to the second crank 12 is defined as the second drawing force F2, the blank pressing force applied by the first blank pressing mechanism to the first blank pressing cam 13 is defined as the first blank pressing force F3, and the blank pressing force applied by the second blank pressing mechanism to the second blank pressing cam 14 is defined as the second blank pressing force F4; on the plane passing the crankshaft 1 axis, the first drawing force F1 and the second drawing force F2 are parallel and opposite to each other and form a first torque N1, the first blank pressing force F3 and the second blank pressing force F4 are parallel and opposite to each other and form a second torque N2, and the first torque N1 is opposite to the direction of the second torque N2, so as to maintain the balance of overall torque on the plane passing the crankshaft 1 axis during the operation of the bodymaker.

The following the description about the other embodiments and structural variations of the present invention:

1. In the above embodiment, as shown in FIG. 2, the first crank 11 and the second crank 12 are arranged adjacently in the axial direction of the crankshaft 1, the first blank pressing cam 13 is arranged outside the axial direction of the first crank 11, and the second blank pressing cam 14 is arranged outside the axial direction of the second crank 12. The invention is not limited to this, instead, the first blank pressing cam 13 and the second blank pressing cam 14 are arranged adjacently in the axial direction of the crankshaft 1, the first crank 11 is arranged outside the axial direction of the first blank pressing cam 13, and the second crank 12 is arranged outside the axial direction of the second blank pressing cam 14. It can even be changed to other configurations, but it is essentially required that the first torque N1 is opposite to the second torque N2 and can play the role of balancing torque on the plane passing the axis of crankshaft 1.
2. In the above embodiment, it adopts two blank pressing cams and arranges the first driving point of the first blank pressing cam 13 opposite to the second driving point of the second blank pressing cam 14, and finally, the directions of the first torque N1 and the second torque N2 are opposite and they counteract each other, so as to maintain the balance of overall torque on the plane passing the crankshaft axis during the operation of the bodymaker. In fact, in the present invention, it is an essential condition that the direction of the first torque N1 is opposite to that of the second torque N2, but whether the first torque N1 and the second torque N2 completely counteracting each other is not an essential condition, which should be determined according to the specific design. Complete counteracting is the optimal option, but partial counteracting is also allowed, which can be finally confirmed according to the comprehensive effect.
3. In the above embodiment, two identical connecting rods 2 are adopted, i.e. the first connecting rod 21 and the second connecting rod 22. Two identical slide rails 3 are adopted, i.e. the first slide rail 31 and the second slide rail 32. Two identical sliders 4 are adopted, i.e. the first slider 41 and the second slider 42. Two identical punches 5 are adopted, i.e. the first punch 51 and the second punch 52. But the invention is not limited to this, for example, the first connecting rod 21 and the second connecting rod 22 may have different shapes or sizes. The first slider 41 and the second slider 42 may have different shapes or sizes.
4. In the above embodiment, the specific structure and form of blank pressing mechanism are not described, because the blank pressing mechanism is an indispensable part of the bodymaker, but the specific structure and form of the blank pressing mechanism in the present invention do not affect the expression and embodiment of the innovative content of the invention. Therefore, in above described technical solution, only the term of blank pressing mechanism is defined, and its specific structure and form are not defined. In fact, what kind of blank pressing mechanism is adopted is not relevant with the invention. As long as the blank pressing mechanism can cooperate with the first blank pressing cam 13 and the second blank pressing cam 14 on the crankshaft 1, the purpose of the invention can be achieved and the expected effect of the invention can be achieved.
5. In the above embodiment, the first drawing force F1 corresponds to the first punch driving mechanism, the first blank pressing force F3 corresponds to the first blank pressing mechanism, while the first punch driving mechanism and the first blank pressing mechanism act on the same drawn can blank. The second drawing force F2 corresponds to the second punch driving mechanism, the second blank pressing force F4 corresponds to the second blank pressing mechanism, while the second punch driving mechanism and the second blank pressing mechanism act on the another same drawn can blank. However, the invention is not limited to this. The first blank pressing force F3 shown in FIG. 2 can be switched with the second blank pressing force F4, that is, the first blank pressing mechanism corresponding to the first blank pressing force F3 can be matched with the second punch driving mechanism, and the second blank pressing mechanism corresponding to the second blank pressing force F4 can be matched with the first punch driving mechanism.

It should be noted that the above described embodiments are only for illustration of technical concept and characteristics of present invention with purpose of making those skilled in the art understand the present invention, and thus these embodiments shall not limit the protection range of present invention. The equivalent changes or modifications according to spiritual essence of present invention shall fall in the protection scope of present invention.

1. A bi-directional and double-punch balanced high-speed bodymaker, which comprises a punch driving mechanism and a blank pressing mechanism, wherein: the punch driving mechanism is composed of the following components:
a crankshaft, and the crankshaft is rotationally supported by a bearing, and the crankshaft is provided with a first crank, a second crank, a first blank pressing cam and a second blank pressing cam,
two connecting rods, the first connecting rod and the second connecting rod;
two slide rails, the first slide rail and the second slide rail;
two sliders, the first slider and the second slider;
two punches, the first punch and the second punch;
wherein:
the first crank is rotationally connected with the one end of the first connecting rod, and the other end of the first connecting rod is rotationally connected with the first slider, and the first slider is mounted on the first slide rail and slidably connected relative to the first slide rail, and the first slide rail is fixed relative to the base of the bodymaker, and the first slider is fixedly connected with the first punch;
the second crank is rotationally connected with one end of the second connecting rod, and the other end of the second connecting rod is rotationally connected with the second slider, and the second slider is mounted on the second slide rail 32 and slidably connected relative to the second slide rail and the second slide rail is fixed relative to the base of the bodymaker, and the second slider is fixedly connected with the second punch;
the first crank, the first connecting rod, the first slider, the first slide rail, the first punch and the first blank pressing cam are located at one end of the crankshaft and form a first punch driving mechanism; the second crank, the second connecting rod, the second slider, the second slide rail, the second punch and the second blank pressing cam are located at the other end of the crankshaft and form a second punch driving mechanism;
the blank pressing mechanism is composed of a first blank pressing mechanism and a second blank pressing mechanism, wherein the first blank pressing mechanism is arranged corresponding to the first punch driving mechanism, the first blank pressing cam is drivingly connected with the first blank pressing mechanism and has a first driving point, the second blank pressing mechanism is arranged corresponding to the second punch driving mechanism, and the second blank pressing cam is drivingly connected with the second blank pressing mechanism and has a second driving point;
on the plane transverse to the crankshaft axis, the first punch driving mechanism and the second punch driving mechanism are symmetrically arranged with the rotation center point of the crankshaft as the reference;
on the plane passing the axis of crankshaft, the turning direction of the first crank is opposite to that of the second crank, and the first blank pressing cam and the second blank pressing cam are fixedly connected relative to the crankshaft, and at the same time, on the plane passing the crankshaft axis, the first driving point of the first blank pressing cam is opposite to the second driving point of the second blank pressing cam; in the working state, the drawing force applied by the first connecting rod to the first crank is defined as the first drawing force, and the drawing force applied by the second connecting rod to the second crank is defined as the second drawing force, the blank pressing force applied by the first blank pressing mechanism to the first blank pressing cam is defined as the first blank pressing force, and the blank pressing force applied by the second blank pressing mechanism to the second blank pressing cam is defined as the second blank pressing force; on the plane passing the crankshaft axis, the first drawing force and the second drawing force are parallel and opposite to each other and form a first torque, the first blank pressing force and the second blank pressing force are parallel and opposite to each other and form a second torque, and the first torque is opposite to the direction of the second torque.

2. The bodymaker of claim 1, wherein: the first crank and the second crank are arranged adjacently in the axial direction of the crankshaft, the first blank pressing cam is arranged outside the axial direction of the first crank, and the second blank pressing cam is arranged outside the axial direction of the second crank.

3. The bodymaker of claim 1, wherein: the first blank pressing cam and the second blank pressing cam are arranged adjacently in the axial direction of the crankshaft, the first crank is arranged outside the axial direction of the first blank pressing cam, and the second crank is arranged outside the axial direction of the second blank pressing cam.
